(19) United States
(12) Patent Application Publication
(10) Pub. No.: US 2010/0057428 A1
(43) Pub. Date: Mar. 4, 2010

(54) Method and computer system for the computer simulation of a plant or a machine

(75) Inventor: Joerg Jeschin, Einbeck (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Phoenix Contact GmbH & Co. KG

(21) Appl. No.: 12/459,642

(22) Filed: Jul. 6, 2009

(30) Foreign Application Priority Data
Jul. 4, 2008 (DE) 102008031427.7-53

(51) Int. Cl. G06G 7/66

(52) U.S. Cl. 703/18

(57) ABSTRACT

For solution of the problem of creating a possibility for a comprehensive computer simulation of a plant or machine, the invention proposes a method for the simulation of a plant or a machine by means of a computer, in particular a personal computer, which has at least two core processors, in which a simulation program for simulating at least one process of a plant or machine to be simulated is executed on at least one first core processor and a user program of a programmable logic controller for simulating a programmable logic controller of a plant or machine to be simulated is executed on at least one second core processor and, between the simulation program and the user program, input and output data are transmitted via a transparent channel. For carrying out the method, the method further proposes a computer system having at least two core processors.

### CROSS REFERENCE TO RELATED APPLICATIONS

This application claims benefit under 35 U.S.C. §119(a) of German Patent Application No. 10-2008-031-427.7-53, filed Jul. 4, 2008, the entire contents of which are incorporated herein by reference.

### BACKGROUND OF THE INVENTION

1. Field of the Invention

The present invention relates to a method and a computer system for the computer simulation of a plant or a machine, in particular a wind power plant (WPP).

2. Description of Related Art

The increasing complexity of modern plants and machines is associated also with an increase in the requirements in terms of simulating such systems for purposes of testing and analysis. Becoming ever more urgent in this regard are, in particular, the possibilities for comprehensive computer simulations, which, even without the actual construction of the plant or machine, permit extensive investigations.

For example, manufacturers of wind power plants or the operators of so-called wind parks, in which a number of wind power plants are operated in a total system, need the possibility of being able to investigate their plants in terms of, for instance, various fault scenarios or various wind conditions, including marginal conditions that may not occur in reality.

In the meantime, there have been various suppliers who have offered solutions for the simulation of input/output systems (IO systems)(e.g., Mewes and Partners for INTERBUS, PROFINET, etc.) and thus pursued various approaches.

Thus, one approach provides that, by means of a PC system, the actual process of a plant or a machine is simulated and then a true programmable logic controller (PLC) of this plant or machine processes input data produced in this way with its user program and generates corresponding output data.

A drawback in this case is that, in essence, only a small degree of computer simulation is achieved.

Another approach provides for the simulation, by means of a PC system, of the PLC of a plant or a machine by running the user code or user program written for a PLC on a PC system as a non-real-time application, whereby the actual process of the plant or machine is not generally simulated, but rather the input data are to be entered here beforehand by hand.

In this type of simulation, a key drawback is that, often, the special functions and the real-time capability of the PLC or the IO system are disregarded.

### BRIEF SUMMARY OF THE INVENTION

One problem of the present invention is therefore to create a possibility for a comprehensive computer simulation of a plant or a machine.

Another aspect of the invention is to be regarded as being that, during the computer simulation, it is possible to take into consideration real-time conditions and the capability of the IO system to update data ever faster and thus to generate correspondingly more data.

Another aspect of the invention further consists in being able to investigate a total system made up of a number of plants or machines during the computer simulation.

Provided in accordance therewith is a method for the simulation of a plant or a machine by means of a computer, in particular a personal computer, which has at least two core processors. In this method, a simulation program for simulating a process of a plant or machine to be simulated is executed on at least one first core processor and a user program of a programmable logic controller for simulating a programmable logic controller of a plant or machine to be simulated is executed on at least one second core processor and, between the simulation program and the user program, input and output data are transmitted via a transparent channel.

Advantageous and/or preferred embodiments and further developments of the method, which also take into consideration the aspects mentioned further above, are described herein.

Thus, the method preferably provides that the transparent channel is a communication interface supplied by means of an executed driver program.

In the method, the operating system of the computer is appropriately a real-time operating system (RTOS) or a non-real-time operating system (NRTOS), in particular a multipurpose operating system (OS), such as, for example, Microsoft Windows, which, however, has been expanded to include the real-time capability by means of a further executed add-on program, so that the simulation of the process and/or the programmable logic controller can occur taking into consideration real-time conditions.

Preferably, in the method, a user program of a programmable logic controller for simulating another programmable logic controller of a total system made up of a number of plants or machines is executed, in each case, on each additional second core processor.

Appropriately, in the method, each user program of a programmable logic controller is executed, in each case, in one instance of a runtime environment.

In the method, the core processors are, particularly preferably, a component part of at least one multicore processor.

Particularly preferably in the method, furthermore, a virtual network interface controller (NIC) can be assigned to each simulated programmable logic controller, so that, between the simulated programmable logic controllers, data, in particular TCP/IP-based data, can be transmitted.

The invention thus represents a method by means of which it is possible, in a simple manner, to simulate comprehensively a plant or machine on a computer.

On the other hand, the aforementioned technical problem is solved by way of a computer system.

Provided in accordance therewith is a computer system for simulating a plant or machine, provided with an least one computer, which has at least two core processors, with the first core processor being designed to execute a simulation program for simulating at least one process of a plant or machine to be simulated and the second core processor being designed to execute a user program of a programmable logic controller for simulating a programmable logic controller of a plant or machine to be simulated, and with a transparent channel between the simulation program and the user program via which the input and output data can be transmitted.

According to an advantageous embodiment, the computer system includes at least one further computer having at least one core processor, with each of the computers having, in each case, a physical network interface controller (NIC) for exchanging data via the network connection.

These and further features, as well as advantages of the invention associated therewith, ensue from the more detailed description of a preferred exemplary embodiment below, with reference to the attached drawings.

### BRIEF DESCRIPTION OF THE SEVERAL VIEWS OF THE DRAWINGS

FIG. 1 is a schematic illustration of the implementation of the method using two core processors PK1 and PK2 for simulating a wind power plant; and

FIG. 2 is a schematic illustration of the implementation of the method using four core processors PK1, PK2, PK3, and PK4 for simulating a wind park made up of two wind power plants WA1 and WA2 as well as a wind park controller WS.

### DETAILED DESCRIPTION OF THE INVENTION

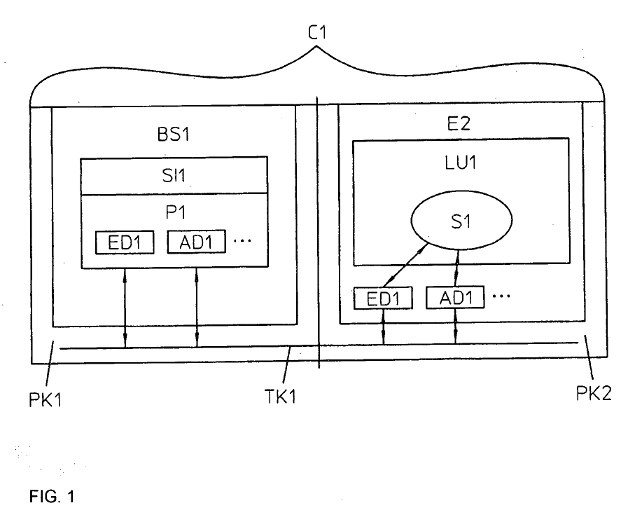

In the example illustrated in FIG. 1, the method is carried out for simulating a single wind power plant. In this case, a computer C1, which has a total of two core processor PK1 and PK2, is used, with the core processors PK1 and PK2 being a component part of a dual-core processor. However, it would equally be possible for two single-core processors to be installed on the mainboard of the computer C1. The computer C1 can be a personal computer, a laptop computer, or a notebook computer.

On the one hand, the operating system BS1 of the computer C1 is executed on the core processor PK1; on the other hand, the core processor PK1 is used for the process simulation PS1, that is, for the simulation of a process P1 of the wind power plant.

To this end, besides the operating system BS1, the simulation program SI1, by means of which the process P1 is simulated, is executed on the core processor PK1. The operating system BS1 can be, for example, Microsoft Windows; the simulation program SI1 can be, for example, MATLAB-Simulink of The MathWorks.

The core processor PK2 of the computer C1 is used exclusively for the PLC simulation SS1, that is, for the simulation of the PLC S1 of the wind power plant. To this end, one instance of a runtime environment LU1 is executed on the core processor PK2 and further permits the user program of the PLC S1 of the wind power plant to be executed.

Furthermore, in the example illustrated in FIG. 1, one instance of an add-on program E2 is executed on the core processor PK2, which expands the operating system BS1, which, in itself, is not real-time capable, by real-time capability, so that at least PLC S1 can also be simulated under real-time conditions. Moreover, if need be, it is possible also to execute one instance of the add-on program E1 on the core processor PK1 for real-time expansion, so that it is possible to simulate the process P1 of the wind power plant as well.

Such a real-time expansion of the operating system BS1 is not needed, by contrast, when a real-time operating system is used, which is in itself already real-time capable, or when, in simulation, there is no importance given to taking into consideration real-time conditions.

Depending on the scenario being investigated, corresponding input data ED1—for example, those of wind speed sensors of the wind power plant to be simulated under certain prevailing wind speeds—are generated by means of the process simulation PS1 running on the core processor PK1 and are then transmitted via a so-called transparent channel TK1, which involves a communication interface realized by means of a driver program, to the PLC simulation SS1 running on the core processor PK2.

These input data ED1 are subsequently processed by the PLC simulation SS1, taking into consideration, in particular, the rule algorithms deposited in the user program, and corresponding output data AD1 are generated, which, in turn, are transmitted via the transparent channel TK1 to the process simulation PS1. There, based on the output data AD1 of the PLC simulation SS1, a braking of the rotor or a change in the angle of attack of the rotor blades, for example, of the wind power plant is then simulated and new input data ED1 are generated from this.

In other words, the IO data ED1/AD1 of the simulation program SI1 is transmitted to the user program of the PLC S1 and vice versa.

The exchange of the IO data ED1/AD1 between the process and the PLC simulation PS1, SS1 via the transparent channel TK1 can take place in such a manner, for example, that the data is copied by means of a suitable driver program from the IO image of the process simulation PS1 to the IO image of the PLC simulation SS1 and vice versa, it being possible to utilize known mechanisms for this, such as shared memory, queues, and/or events.

In this way, it is possible to investigate the behavior of wind power plants under, for instance, various wind and weather conditions, without having to construct the plant in actuality.

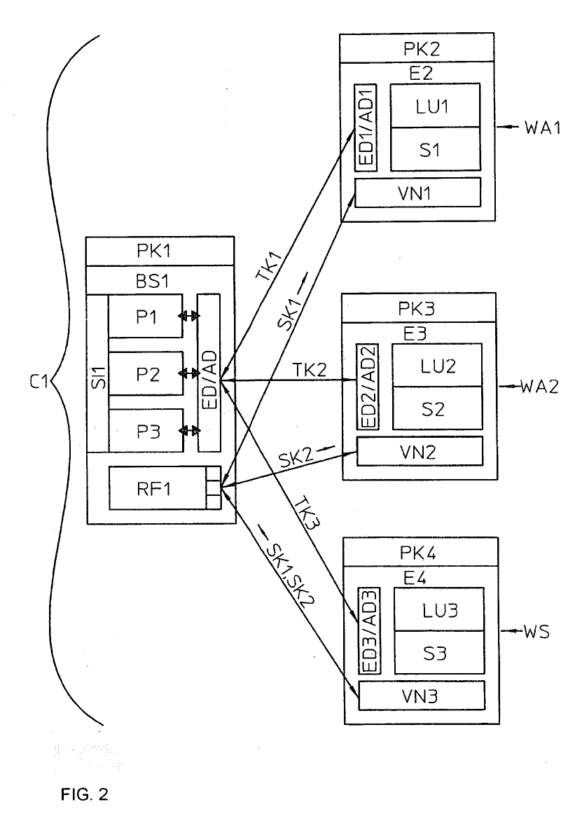

In the example illustrated in FIG. 2, the method is carried out for the simulation of a wind park, to which two wind power plants WA1 and WA2 as well as a central wind park controller WS belong. Employed to this end is a computer C1, which disposes over a total of four core processors. The core processors PK1, PK2, PK3, and PK4 are, in this case, a component part of quad-core processor, but they could also belong to four single core or two dual-core processors, which are installed on the mainboard of the computer C1. Other possibilities will be described further below.

Executed on the core processor PK1 in this example, too, is, besides the operating system BS1 of the computer C1, the simulation program SI1, by means of which now, however, the processes P1, P2, P3 of the two wind power plants WA1, WA2 and the wind park control WS are simulated.

The three PLCs S1, S2, S3 required for this example are simulated, in each case, on one of the three remaining core processors PK2, PK3, and PK4 of the computer C1 in such a manner that, on each of the three core processors, one instance of the runtime environment LU1, LU2, LU3 for a PLC user program is executed, with, in detail, the user program of the PLC S1 of the wind power plant WA1 to be simulated being executed on the core processor PK2, the user program of the PLC S2 of the wind power plant 2 being executed on the core processor PK3, and the user program of the PLC S3 of the wind park controller WS being executed on the core processor PK4.

Between each of the PLC simulations SS1, SS2, SS3 and the respectively associated process simulations PS1, PS2, PS3, the IO data ED1/AD1, ED2/AD2, and ED3/AD3 can be exchanged via the respectively assigned transparent channel TK1, TK2, TK3.

Furthermore, a virtual network interface VN1, VN2, VN3 is assigned to each of the PLC simulations SS1, SS2, SS3. These are linked to the virtual network interfaces of the operating system BS1, with the operating system BS1 providing a routing function RF1, so that the three PLC simulations SS1, SS2, SS3 are also linked to one another and, in this way, data can be exchanged. Accordingly, it is possible that the PLC simulation SS3 of the wind park controller WS sends control commands SK1, SK2—for example, TCP/IP-based ones—to one of the PLC simulations SS1, SS2 of the wind power plants WA1, WA2 or else to both of them. Alternatively, the sending of the control commands SK1, SK2 can take place by means of IO data via the respective transparent channels TK1, TK2, TK3, with the data being copied by means of a suitable driver program from the IO image of the PLC simulation SS3 of the wind park controller WS to the IO image of one of the PLC simulations SS1, SS2 of the wind power plants WA1, WA2 or to both of them.

In order to be able to simulate the three SPS S1, S2, S3 under real-time conditions, each of the three core processors PK2, PK3, and PK4 also executes, in each case, one instance of an add-on program E2, E3, E4 for real-time expansion of the operating system BS1, which, in itself, is not real-time capable. Furthermore, on the core processor PK1, one instance of the add-on program E1 can be executed for real-time expansion of the operating system BS1, if it is required also to simulate the processes P1, P2, P3 of the wind power plants WA1 and WA2 and of the wind park controller WS under real-time conditions.

Besides the examples illustrated in FIGS. 1 and 2, there exist other variants for carrying out the method, which will be described below without graphical illustration.

Thus, it is further possible by means of the method to simulate a wind park with more than two wind power plants, WA1, WA2, . . . , WAn, with a further core processor PKn being supplied for each PLC Sn of a WPP WAn to be simulated. Although computers or processors with more than four core processors are already available today, so that the simulation of larger wind parks or larger total systems in generally possible on only one computer, the further required core processors Pn can, in practice, also belong to one or more additional computers C2, . . . , Cn, which are then to be linked to one another via a network connection having an adequately high data transmission rate for the data exchange. In this case, it is fully transparent for the process and PLC simulations PS1, . . . , PSn, SS1, . . . , SSn whether they are run or executed on core processors of one or more computers.

Even a computer that disposes over only one core processor can be utilized as an additional computer for the method. In this case, for example, both one operating system and, if need be, one instance of an add-on program for real-time expansion of the operating system and also the user program of a PLC of a further plant or machine to be simulated as well as one instance of a runtime environment required for this are executed.

Provided that there are an adequate number of available core processors, it is further possible in the method, depending on the requirement and particularly in order to enhance performance, to execute a PLC simulation not only on one core processor, but jointly on several core processors.

There also exists the possibility, in particular for enhancing performance, to execute the operating system and the simulation program jointly on several processors.

In the case of several processes P1, . . . , Pn of plants or machines to be stimulated, it is also possible to execute for each process one individual instance of the simulation program SI1, . . . , SIn. Furthermore, it is possible to execute each of the instances of the simulation program on its own core processor in each case, so that, each of the process simulations runs on one core processor in each case.

### OVERVIEW OF THE REFERENCE SIGNS

WA wind power plant
WS wind park controller
C computer
PK core processor
BS operating system
SI simulation process
P process
LU runtime environment

### S PLC

PS process simulation
SS PLC simulation
E add-on program for real-time expansion
TK transparent channel
ED input data
AD output data
VN virtual network interface
RF routing function
SK control commands

What is claimed is:

1. A method for the simulation of a plant or machine by a computer having at least two core processors, comprising:
executing, on at least one first core processor, a simulation program for simulating at least one process of a plant or machine to be simulated;
executing, on at least one second core processor, a user program of a programmable logic controller for simulating a programmable logic controller of the plant or machine to be simulated; and
transmitting input and output data between the simulation program and the user program via a transparent channel.

2. The method according to claim 1, wherein the transparent channel is a communication interface supplied by an executed driver program.

3. The method according to claim 2, wherein the computer has a real-time operating system or an operating system expanded by real-time capability by an executed add-on program, so that the at least one process and/or programmable logic controller can be simulated taking into consideration real-time conditions.

4. The method according to claim 1, wherein the computer has a real-time operating system or an operating system expanded by real-time capability by an executed add-on program, so that the at least one process and/or programmable logic controller can be simulated taking into consideration real-time conditions.

5. The method according to claim 1, further comprising executing, on an additional second core processor, a user program of a second programmable logic controller for simulating a further programmable logic controller.

6. The method according to claim 5, wherein each user program of a programmable logic controller is executed, in each case, in one instance of a runtime environment.

7. The method according to claim 5, wherein the at least one first and second core processors are a component part of at least one multicore processor.

8. The method according to claim 5, further comprising:
a virtual network interface is assigned to each of the programmable logic controllers, so that ICP/IP-based data can be transmitted between the programmable logic controllers.

9. A computer system for simulating a plant or machine, comprising:
at least one computer, which has at least two core processors, the first core processor being designed to execute a simulation program for simulating at least one process of the plant or machine to be simulated, and the second core processor being designed to execute a user program of a programmable logic controller for simulating a programmable logic controller of the plant or machine to be simulated; and
a transparent channel via which input and output data can be transmitted between the simulation program and the user program.

10. The computer system according to claim 9, further comprising:
at least one further computer having at least one core processor, the computer having, in each case, one physical network interface for exchanging data via a network connection.
